(19) United States
(12) Patent Application Publication
(10) Pub. No.: US 2026/0370149 A1
(43) Pub. Date: Nov. 19, 2026

(54) SINGLE-STAGE AC-TO-DC CONVERTER AND AC-TO-DC CONVERSION APPARATUS

(71) Applicant: DELTA ELECTRONICS, INC., Taoyuan City (TW)

(72) Inventors: Chao-Jui HUANG, Taoyuan City (TW); Yu-Lin LEE, Taoyuan City (TW); Chih-Yang YEH, Taoyuan City (TW)

(21) Appl. No.: 19/338,783

(22) Filed: Sep. 24, 2025

(30) Foreign Application Priority Data
May 15, 2025 (CN) 202510625297.9

(51) Int. Cl. H02M 3/335

(52) U.S. Cl. CPC H02M 3/33576

(57) ABSTRACT

A single-stage AC-to-DC converter includes an input power processing circuit, a zero-voltage auxiliary conversion circuit, and an output circuit. The input power processing circuit receives an AC power source and converts the AC power source into a DC power source. The zero-voltage auxiliary conversion circuit is connected to the input power processing circuit. The output circuit is connected to the zero-voltage auxiliary conversion circuit. The input power processing circuit is used to store energy provided by the DC power source during an energy storage cycle. The output circuit is used to deliver the energy stored in the input power processing circuit to an output side winding of the output circuit during an energy release cycle to generate an output power source.

### BACKGROUND

### Technical Field

The present disclosure relates to an AC-to-DC converter and an AC-to-DC conversion apparatus, and more particularly to a single-stage AC-to-DC converter and an AC-to-DC conversion apparatus.

### Description of Related Art

The statements in this section merely provide background information related to the present disclosure and do not necessarily constitute prior art.

Charging piles provide power to electric vehicles to ensure that they can operate normally. With the increasing popularity of electric vehicles, in order to solve users’ range anxiety, the demand for DC charging piles has also grown rapidly and become mainstream. At the same time, in order to reduce the losses caused by charging, it is necessary to increase the charging efficiency of DC charging piles. Therefore, designing efficient and stable power modules for DC charging piles has broad development prospects.

As the battery specifications of current electric vehicles vary greatly, with the highest voltage range reaching thousands of volts, the semiconductor switches used in high-power, high-output power electronic converters need to have higher voltage stress, which will require higher costs and bring difficulties to the selection of switching components.

In the power modules currently used in DC charging piles, a primary AC-to-DC converter is mainly used to convert AC power into DC power (e.g., 800 Vdc). The DC power is then further adjusted to the voltage required by the electric vehicle (for example, 300 to 400 Vdc or 600 to 900 Vdc) through a one-stage or two-stage DC-to-DC converter. Therefore, the DC-to-DC converter should have a wide output voltage modulation function. Furthermore, the two-stage converter structure brings high cost and circuit complexity.

The power modules used in DC charging piles usually have relatively large power and must meet power factor requirements. Therefore, AC-to-DC converters usually use three-phase power factor correction converters (PFCs). Common three-phase PFC converters can be mainly divided into two-level types (e.g., three-phase six-arm type, three-phase twelve-arm type) and three-level types (e.g., three-phase Vienna).

The three-phase six-arm PFC can achieve higher conversion efficiency when used in low-voltage applications. In high-voltage applications, the voltage stress that the switch components need to withstand is usually equal to the DC bus voltage, which is twice that of the three-level type, and the switch losses will increase accordingly, resulting in higher costs and difficulty in selecting switching components. The three-phase twelve-arm type is equivalent to three single-phase AC-to-DC converters. Its advantage is that each phase can be controlled independently, but the number of switching components required is twice that of the three-phase six-arm type. Therefore, the three-phase twelve-arm type PFC is mainly used in occasions with special requirements, such as three-phase unbalanced or single/three-phase can be used.

The purpose of the three-phase Vienna structure is to solve the problems faced by the three-phase six-arm type in high-power and high-voltage applications. In contrast, the three-phase Vienna structure has a capacitive neutral point, which can halve the voltage stress on each switching component and reduce switching losses. The common Vienna structure is mainly T-type and I-type PFC.

However, the output range of the three-phase Vienna structure is relatively narrow and cannot meet the wide output voltage range requirements of general-purpose DC charging piles. Therefore, it is necessary to add a DC-to-DC converter with a wide output range to meet this requirement.

At present, the DC-to-DC converters used in DC charging piles are mainly high-efficiency DC resonant converters, such as single-phase full-bridge/half-bridge LLC converters or three-phase half-bridge LLC converters. The number of converters connected in parallel is determined according to the required power capacity.

Furthermore, even if an AC-to-DC power module composed of a two-stage high-efficiency power electronic converter is used, the increase in the number of switching components and magnetic components will result in a bulky volume, making it difficult to achieve high power density and higher overall efficiency.

Therefore, how to design a single-stage AC-to-DC converter with a wide output range and an AC-to-DC conversion apparatus to solve the problems and technical bottlenecks in the existing technology has become a critical topic in this field.

### SUMMARY

An objective of the present disclosure is to provide a single-stage AC-to-DC converter. The single-stage AC-to-DC converter includes an input power processing circuit, a zero-voltage auxiliary conversion circuit, and an output circuit. The input power processing circuit receives an AC power source and converts the AC power source into a DC power source. The zero-voltage auxiliary conversion circuit is connected to the input power processing circuit. The zero-voltage auxiliary conversion circuit includes an auxiliary transformer, an auxiliary switch, an auxiliary capacitor, and an auxiliary diode. The auxiliary transformer includes a first side winding and a second side winding. The auxiliary switch is connected to the first side winding. The auxiliary capacitor is connected to the second side winding. The auxiliary diode is connected to the second side winding and the auxiliary capacitor. The output circuit includes an input side winding and an output side winding. The input side winding is connected to the zero-voltage auxiliary conversion circuit. The input power processing circuit stores energy provided by the DC power source during an energy storage cycle. The output circuit delivers the energy stored in the input power processing circuit to the output side winding during an energy release cycle to generate an output power source.

Another objective of the present disclosure is to provide an AC-to-DC conversion apparatus. The AC-to-DC conversion apparatus includes a plurality of single-stage AC-to-DC converters. The input sides of the single-stage AC-to-DC converters are respectively connected to the AC power source, and output sides of the single-stage AC-to-DC converters are connected in parallel or in series to output the output power source.

Accordingly, the present disclosure has the following features and advantages:
1. Compared with the prior art, the circuit proposed in the present disclosure provides input to upper and lower sub-circuits (sub-modules), which can meet the requirement of increasing the upper limit of AC input voltage (for example, AC 220 volts increases to AC 480 volts), while effectively reducing the switching voltage stress of subsequent circuits;
2. By adding the zero-voltage auxiliary conversion circuit 12, the power switch with low switching loss (i.e., the auxiliary switch) is used to achieve zero-voltage switching of the power switch with low conduction loss (i.e., the main switch), thereby increasing the overall efficiency of the power switch;
3. By adjusting the frequency and duty cycle of the switching unit and the parameters of each component, a wide output range and high conversion efficiency can be achieved;
4. The disclosed circuit designs the transformer as a one-to-two transformer. The main switch and auxiliary switch on the primary side of the circuit and the boost auxiliary capacitor can maintain the same voltage stress to achieve twice the output voltage, and the electrical specifications of the components on the secondary side can also be effectively reduced. If the transformer is designed as a one-to-three transformer, a higher output voltage capability can be achieved under the same voltage stress conditions;
5. In practical application, the present disclosure can also add n input sub-circuits in series or in parallel to achieve higher power specifications. If the interleaving control is used, the high-frequency ripple of the circuit output can also be reduced;
6. The sub-circuits mentioned above may be independently controlled and thus can be flexibly connected in series and parallel to realize a higher specification single-phase single-stage AC-to-DC power module or a three-phase single-stage AC-to-DC power module.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a single-stage AC-to-DC converter according to the present disclosure.

FIG. 2 is a circuit diagram of the single-stage AC-to-DC converter wherein an input power processing circuit is implemented according to a first embodiment of the present disclosure.

FIG. 3 is a circuit diagram of the single-stage AC-to-DC converter wherein the input power processing circuit is implemented according to a second embodiment of the present disclosure.

FIG. 4 is a circuit diagram of two single-stage AC-to-DC converters operating in coordination with each other according to the present disclosure.

FIG. 5 is a circuit diagram of two single-stage AC-DC converters wherein an output circuit is implemented according to a second embodiment of the present disclosure.

FIG. 6 is a circuit diagram of n single-stage AC-to-DC converters operating in coordination with each other according to the present disclosure.

FIG. 7 is a circuit diagram of a plurality of single-stage AC-to-DC converters applied to a three-phase circuit operation according to the present disclosure.

FIG. 8 is a schematic waveform diagram of controlling a main switch of the input power processing circuit of FIG. 2 and an auxiliary switch of a zero-voltage auxiliary conversion circuit in a positive half cycle.

FIG. 9A is a schematic waveform diagram of controlling a first switch and a second switch of FIG. 3 and the auxiliary switch of the zero-voltage auxiliary conversion circuit in the positive half cycle.

FIG. 9B is a schematic waveform diagram of controlling the first switch and the second switch of FIG. 3 and the auxiliary switch of the zero-voltage auxiliary conversion circuit in a negative half cycle.

### DETAILED DESCRIPTION

Reference will now be made to the drawing figures to describe the present disclosure in detail. It will be understood that the drawing figures and exemplified embodiments of present disclosure are not limited to the details thereof.

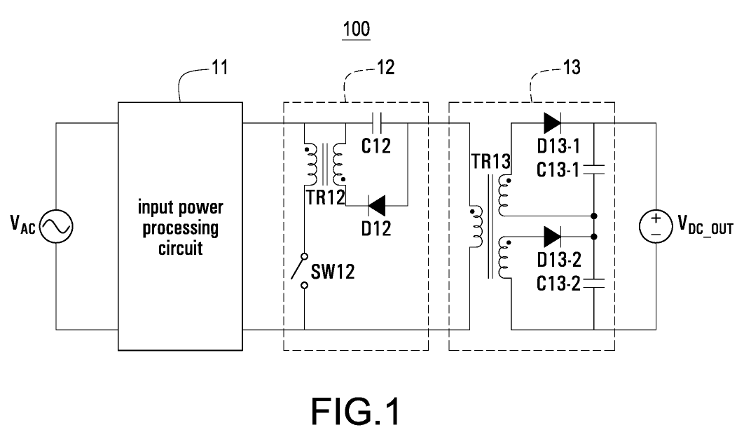

Please refer to FIG. 1, which shows a block circuit diagram of a single-stage AC-to-DC converter according to the present disclosure. The single-stage AC-to-DC converter 100 includes an input power processing circuit 11, a zero-voltage auxiliary conversion circuit 12, and an output circuit 13. Incidentally, “AC” is the abbreviation of alternating current, and “DC” is the abbreviation of direct current. In particular, an input side of the input power processing circuit 11 is used to receive an AC power source V_{AC} (i.e., an AC input power source), and the input power processing circuit 11 converts the AC power source V_{AC} into a DC power source V_{DC}. The converted DC power source V_{DC} is used as a DC input power source for the zero-voltage auxiliary conversion circuit 12.

An input side of the zero-voltage auxiliary conversion circuit 12 is connected to an output side of the input power processing circuit 11. As shown in FIG. 1, the zero-voltage auxiliary conversion circuit 12 includes an auxiliary transformer TR12, an auxiliary switch SW12, an auxiliary capacitor C12, and an auxiliary diode D12. The auxiliary transformer TR12 includes a first side winding and a second side winding. The auxiliary switch SW12 is connected to the first side winding of the auxiliary transformer TR12. The auxiliary capacitor C12 is connected to the second side winding of the auxiliary transformer TR12. The auxiliary diode D12 is connected to the second side winding of the auxiliary transformer TR12 and the auxiliary capacitor C12. Incidentally, in applications requiring high power output, the zero-voltage auxiliary conversion circuit 12 helps reduce the switching loss of a main switch in the input power processing circuit 11 through the assistance of zero voltage switching, which will be described in detail later.

The output circuit 13 includes an input side winding and an output side winding. In particular, the input side winding is connected to an output side of the zero-voltage auxiliary conversion circuit 12. In the embodiment of FIG. 1, the ratio of the number of input side windings to the number of output side windings is 1:2.

The input power processing circuit 11 is used to store energy provided by the DC power source V_{DC} during an energy storage cycle. The output circuit 13 is used to deliver the energy stored in the input power processing circuit 11 to the output side winding of the output circuit 13 during an energy release cycle to generate an output power source V_{DC} _{_} _{OUT}.

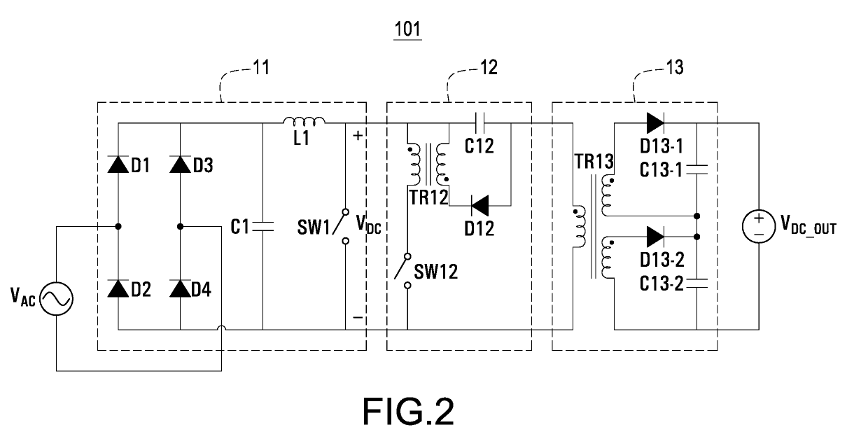

Please refer to FIG. 2, which shows a circuit diagram of the single-stage AC-to-DC converter wherein an input power processing circuit is implemented according to a first embodiment of the present disclosure. The first embodiment of the input power processing circuit 11 shown in FIG. 2 includes a bridge rectifying circuit D1-D4, an inductor L1, and a main switch SW1. The bridge rectifying circuit D1-D4 is composed of four diodes D1-D4 forming a bridge structure, wherein the diodes D1, D2 form a first diode arm and the diodes D3, D4 form a second diode arm. A common connection node of the diodes D1, D2 and a common connection node of the diodes D3, D4 are respectively connected to two terminals of the AC power source V_{AC} to receive the AC power source V_{AC} for rectifying the AC power source V_{AC} to generate an alternating voltage on the capacitor C1. In particular, the capacitor C1 is responsible for filtering the AC power source V_{AC}.

The inductor L1 is connected to the bridge rectifying circuit D1-D4. In this embodiment, a first terminal of the inductor L1 is connected to a cathode side of the two diode arms. The main switch SW1 is coupled to the bridge rectifying circuit D1-D4 in parallel. Specifically, a first terminal of the main switch SW1 is connected to a second terminal of the inductor and a second terminal of the main switch SW1 is connected to an anode side of the two diode arms so that the main switch SW1 is coupled to the bridge rectifying circuit D1-D4 in parallel through the inductor L1. Furthermore, a first terminal of the first side winding of the auxiliary transformer TR12 is connected to the inductor L1 and the main switch SW1, and a second terminal of the first side winding of the auxiliary transformer TR12 is connected to the auxiliary switch SW12 in series. Furthermore, a first terminal of the second side winding of the auxiliary transformer TR12 is connected to a first terminal of the auxiliary capacitor C12, a second terminal of the second side winding of the auxiliary transformer TR12 is connected to a cathode of the auxiliary diode D12, and a second terminal of the auxiliary capacitor C12 is connected to an anode of the auxiliary diode D12.

The single-stage AC-to-DC converter shown in FIG. 2 will be described below. Since the positive half cycle and the negative half cycle of the AC power source V_{AC} are symmetrical, only the positive half cycle of the AC power source V_{AC} is taken as an example for explanation.

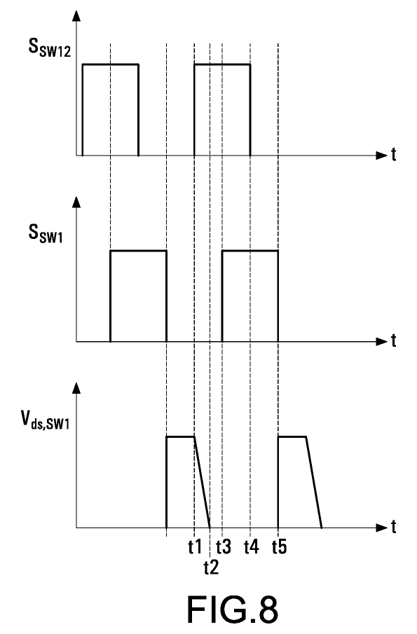

Please refer to FIG. 8, which shows a schematic waveform diagram of controlling a main switch of the input power processing circuit of FIG. 2 and an auxiliary switch of a zero-voltage auxiliary conversion circuit in a positive half cycle. First, at time t1, the main switch SW1 of the input power processing circuit 11 is turned off, and the auxiliary switch SW12 of the zero-voltage auxiliary conversion circuit 12 is turned on. Therefore, the input current provided by the AC power source V_{AC} flows through the first side winding of the auxiliary transformer TR12 of the zero-voltage auxiliary conversion circuit 12. Furthermore, the current of the second side winding of the auxiliary transformer TR12 of the zero-voltage auxiliary conversion circuit 12 also flows through the first side winding. As the current flowing through the first side winding of the auxiliary transformer TR12 increases, the drain-source voltage (i.e., a voltage across the drain and the source) of the main switch SW1 gradually decreases. Until time t2, the drain-source voltage of the main switch SW1 is zero, and the main switch SW1 can be controlled to be turned on at time t3, thereby reducing the switching loss of the main switch SW1. At this point, whether the current flowing through the main switch SW1 is greater or smaller than that through the auxiliary switch SW12 depends on the impedance of the current paths, which is not the focus of the present disclosure.

Afterwards, at time t4, the auxiliary switch SW12 is controlled to be turned off. Therefore, the input current provided by the AC power source V_{AC} flows through the main switch SW1, and the current of the second side winding of the auxiliary transformer TR12 flows into the auxiliary capacitor C12, thereby realizing energy recovery of the parasitic capacitance of the main switch SW1. Therefore, the period from time t1 to time t4 is an energy storage period, that is, the input power source stores energy in the inductor L1 of the input power processing circuit 11 to prepare for transferring the energy to an output power source V_{DC_OUT}.

Until time t5, the main switch SW1 is controlled to be turned off. Under this condition, since the main switch SW1 and the auxiliary switch SW12 are both turned off, the energy stored in the inductor L1 charges the auxiliary capacitor C12 of the zero-voltage auxiliary conversion circuit 12, and is transmitted to the output side winding of the output circuit 13 through the zero-voltage auxiliary conversion circuit 12 to generate the output power source V_{DC_OUT}, and therefore this period is referred to as the energy release cycle of the inductor L1. Specifically, the energy transmitted to the output winding of the output circuit 13 will be stored in the capacitors C13-1, C13-2 connected to the output side winding so that a stable DC output can be generated in a steady state. In particular, the path of transferring energy to the output side winding of the output circuit 13 may be determined according to the polarities of the input side winding and the output side winding of the output circuit 13.

Therefore, the operating characteristics of the single-stage AC-to-DC converter shown in FIG. 2 are as follows: the change in the on-time of the main switch SW1 causes the inductor L1 to store energy so that it charges the auxiliary capacitor C12 (i.e., a boost capacitor) of the zero-voltage auxiliary conversion circuit 12 when the main switch SW1 is turned off, and at the same time, the voltage gain of the output power source V_{DC_OUT} is adjusted through a transformer TR13 of the output circuit 13.

The auxiliary capacitor C12 and the input side winding (i.e., the primary side winding) of the transformer TR13 form an LC circuit. When the main switch SW1 is turned on, the auxiliary capacitor C12 charges the primary side winding of the transformer TR13 to achieve energy transfer.

In particular, the energy of the output side winding (i.e., the secondary side winding) of the one-to-two transformer TR13 is rectified by the half-wave rectifying diode unit D13-1, D13-2 and then connected in series to achieve a higher output gain.

Furthermore, the zero-voltage auxiliary conversion circuit 12 can recover the energy stored in the parasitic capacitance of the main switch SW1 when the main switch SW1 is turned off so as to achieve zero voltage turn-on of the main switch SW1 and reduce the switching loss of the main switch SW1. In other words, in order to reduce the switching loss of the main switch SW1, the auxiliary switch SW12 of the zero-voltage auxiliary conversion circuit 12 is controlled to be turned on earlier than the main switch SW1 during the energy storage period. Furthermore, when the voltage across the main switch SW1 is zero, the main switch SW1 is controlled to be turned on. Taking the main switch SW1 as a MOSFET power switch as an example, after the auxiliary switch SW12 is controlled to be turned on, when the drain-source voltage of the main switch SW1 is zero, the main switch SW1 is controlled to be turned on, thereby reducing the switching loss of the main switch SW1.

Therefore, a single single-stage AC-to-DC converter may be a module structure, and therefore three single-stage AC-to-DC converters may be used in a three-phase power conversion structure.

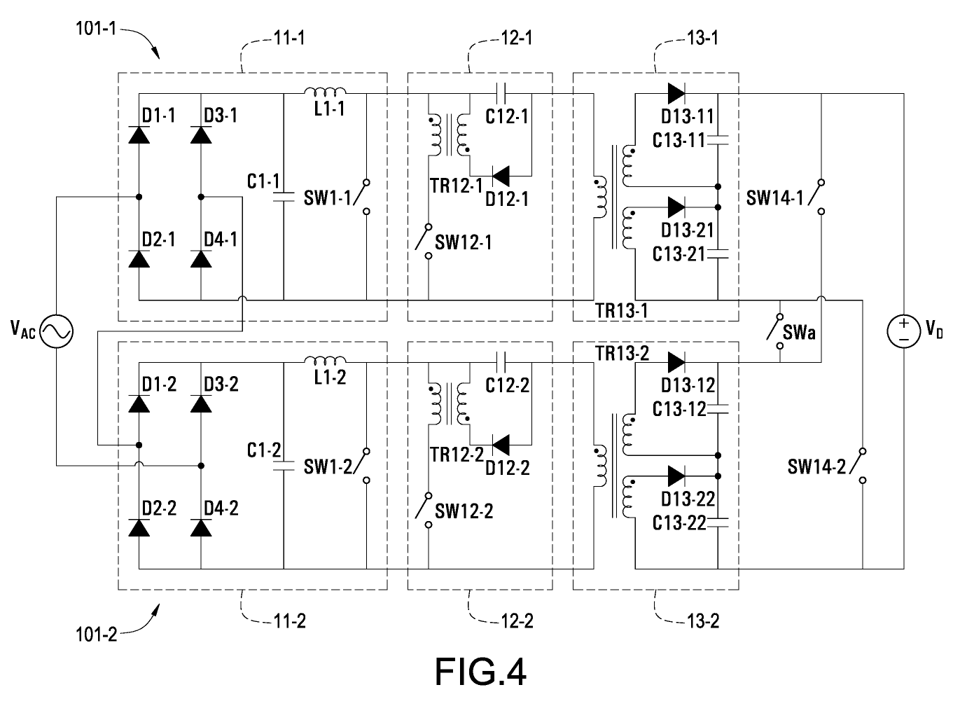

Please refer to FIG. 4, which shows a circuit diagram of two single-stage AC-to-DC converters operating in coordination with each other according to the present disclosure, that is, the signal-stage isolation converter includes two single-stage AC-to-DC converters as shown in FIG. 2. In other words, two modular single-stage AC-to-DC converters are connected in series and parallel for use. Since each modular single-stage AC-DC converter has been described in the above-mentioned content corresponding to FIG. 2, it will not be described in detail here.

In particular, the two main switches SW1-1, SW1-2 and the two auxiliary switches SW12-1, SW12-2 of the two single-stage AC-to-DC converters shown in FIG. 4 are usually controlled synchronously, or the two main switches SW1-1, SW1-2 and the two auxiliary switches SW12-1, SW12-2 can also be controlled interleavingly, which can reduce the high-frequency ripple output by the circuit. The synchronous control means that the two main switches SW1-1, SW1-2 are turned on and turned off at the same time, and the two auxiliary switches SW12-1, SW12-2 are turned on and turned off at the same time. That is, when the first modular single-stage AC-to-DC converter operates in the energy storage cycle, the other modular single-stage AC-to-DC converter also operates in the energy storage cycle; when the first modular single-stage AC-to-DC converter operates in the energy release cycle, the other modular single-stage AC-to-DC converter also operates in the energy release cycle.

The interleaving control means that when the main switch SW1-1 is turned on, the main switch SW1-2 is turned off, when the auxiliary switch SW12-1 is turned on, the auxiliary switch SW12-2 is turned off; when the main switch SW1-1 is turned off, the main switch SW1-2 is turned on, when the auxiliary switch SW12-1 is turned off, the auxiliary switch SW12-2 is turned on. That is, when the first modular single-stage AC-to-DC converter operates in the energy storage cycle, the other modular single-stage AC-to-DC converter operates in the energy release cycle; when the first modular single-stage AC-to-DC converter operates in the energy release cycle, the other modular single-stage AC-to-DC converter operates in the energy storage cycle.

Incidentally, all diodes and series-parallel switching switch units SW14-1, SW14-2, SWa in the circuit may be replaced with switching components with low conduction losses (e.g., MOSFETs, IGBTs, etc.), thereby optimizing the overall efficiency of the circuit.

The circuit diagram of FIG. 4 is only a combination of two upper and lower modules connected in series. However, in practice, more sets of the same circuit units may be connected in series or more circuit units may be connected in parallel instead in response to the input voltage, the output voltage, and component specification restrictions.

The output range of a single circuit unit is usually limited (for example, 75 to 500 volts). The series-parallel output structure is formed by switching the switch unit. For example, the switch SWa may connect the output terminals of different modules in series, and the switch SW14-1 and the switch SW14-2 may connect the output terminals of different modules in parallel so as to achieve a wide voltage range and a wide load range (for example 150 to 1000 volts) by switching the circuit gain provided to cope with different applications.

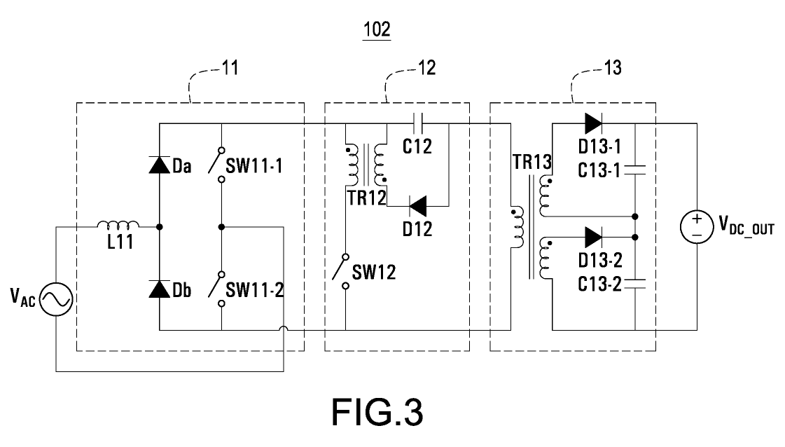

Please refer to FIG. 3, which shows a circuit diagram of the single-stage AC-to-DC converter wherein the input power processing circuit is implemented according to a second embodiment of the present disclosure. Compared with FIG. 2 which is a bridge-type structure, FIG. 3 is a bridgeless structure. In the second embodiment of the input power processing circuit 11 shown in FIG. 3, the input power processing circuit 11 includes an inductor L11, a diode arm, and a switch arm. The inductor L11 receives an AC power source V_{AC}. The diode arm includes a first diode Da and a second diode Db connected in series. The switch arm is connected to the bridge arm in parallel, and includes a first switch SW11-1 and a second switch SW11-2 connected in series. A common connection node of the first diode Da and the second diode Db and a common connection node of the first switch SW11-1 and the second switch SW11-2 are respectively connected to two terminals of the AC power source V_{AC} to receive the AC power source V_{AC} for rectifying the AC power source V_{AC}. More specifically, the common connection node of the first diode Da and the second diode Db is connected to a first terminal of the AC power source V_{AC} through the inductor L11, and the common connection node of the first switch SW11-1 and the second switch SW11-2 is directly connected to a second terminal of the AC power source V_{AC}.

Furthermore, a first terminal of the first side winding of the auxiliary transformer TR12 is connected to the diode arm and the switch arm, and a second terminal of the first side winding of the auxiliary transformer TR12 is connected to the auxiliary switch SW12 in series. Furthermore, a first terminal of the second side winding of the auxiliary transformer TR12 is connected to a first terminal of the auxiliary capacitor C12, a second end of the second side winding of the auxiliary transformer TR12 is connected to a cathode of the auxiliary diode D12, and a second terminal of the auxiliary capacitor C12 is connected to an anode of the auxiliary diode D12.

Compared to the bridge structure shown in FIG. 2, the bridgeless structure of FIG. 3 does not have the main switch SW1 shown in FIG. 2, but is replaced by a first switch SW11-1 and a second switch SW11-2 responsible for the positive half-cycle and the negative half-cycle operations respectively. Furthermore, the inductor L1 connected between the bridge rectifying circuit D1-D4 and the main switch SW1 shown in FIG. 2 is replaced by an inductor L11 for receiving the AC power source V_{AC}. Furthermore, in multi-module applications, the inductor L11 is connected to the AC power source V_{AC} and serves as a shared input inductor. Incidentally, compared to FIG. 2, the bridgeless structure used in FIG. 3 can reduce the number of components, thereby reducing the heat loss and overall power consumption of the circuit.

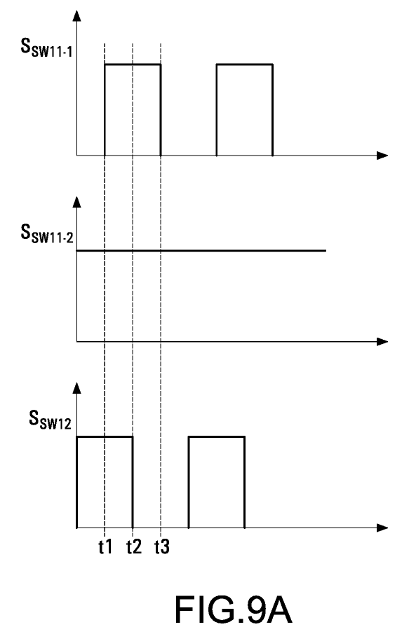

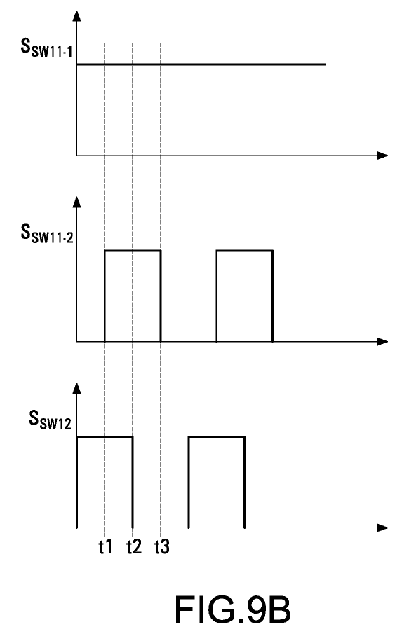

The single-stage AC-to-DC converter shown in FIG. 3 will be described below. In particular, the positive half cycle and the negative half cycle of the AC power source V_{AC} are operated symmetrically. Please refer to FIG. 9A, which shows a schematic waveform diagram of controlling a first switch and a second switch of FIG. 3 and the auxiliary switch of the zero-voltage auxiliary conversion circuit in the positive half cycle. When the AC power source V_{AC} is in the positive half cycle, at time t1, the first switch SW11-1 is turned on, the second switch SW11-2 is constantly turned on, and the auxiliary switch SW12 of the zero-voltage auxiliary conversion circuit 12 is turned on. At time t2, the first switch SW11-1 remains turned on, the second switch SW11-2 is constantly turned on, and the auxiliary switch SW12 is turned off. Until time t3, the first switch SW11-1 is turned off, the second switch SW11-2 is constantly turned on, and the auxiliary switch SW12 is still turned off. By controlling the first switch SW11-1, the second switch SW11-2, and the auxiliary switch SW12 (that is, the first switch SW11-1 and the auxiliary switch SW12 are switched at high frequency, and the second switch SW11-2 is constantly turned on), the energy storage and energy release operations of the input power processing circuit 11 when the AC power source V_{AC} is in the positive half cycle are achieved, and a stable output power source V_{DC} _{_} _{OUT} can be generated in the steady state. Incidentally, for the control of FIG. 9A, the auxiliary switch SW12 is also controlled to be turned on first, and then the first switch SW11-1 is controlled to be turned on at zero across voltage so that the switching loss can be reduced. In addition, since the second switch SW11-2 is constantly turned on (not high-frequency switching) during the positive half cycle, the switching loss can be reduced.

Please refer to FIG. 9B, which shows a schematic waveform diagram of controlling the first switch and the second switch of FIG. 3 and the auxiliary switch of the zero-voltage auxiliary conversion circuit in a negative half cycle. When the AC power source V_{AC} is in the negative half cycle, at time t1, the first switch SW11-1 is constantly turned on, the second switch SW11-2 is turned on, and the auxiliary switch SW12 of the zero-voltage auxiliary conversion circuit 12 is turned on. At time t2, the first switch SW11-1 is constantly turned on, the second switch SW11-2 remains turned on, and the auxiliary switch SW12 is turned off. Until time t3, the first switch SW11-1 is constantly on, the second switch SW11-2 is turned off, and the auxiliary switch SW12 is still turned off. By controlling the first switch SW11-1, the second switch SW11-2, and the auxiliary switch SW12 (that is, the second switch SW11-2 and the auxiliary switch SW12 are switched at high frequency, and the first switch SW11-1 is constantly turned on), the energy storage and energy release operations of the input power processing circuit 11 when the AC power source V_{AC} is in the negative half cycle are achieved, and a stable output power source V_{DC} _{_} _{OUT} can be generated in the steady state. Incidentally, for the control of FIG. 9B, the auxiliary switch SW12 is also controlled to be turned on first, and then the second switch SW11-2 is controlled to be turned on at zero across voltage so that the switching loss can be reduced. In addition, since the first switch SW11-1 is constantly turned on (not high-frequency switching) during the negative half cycle, the switching loss can be reduced. As mentioned above, in a multi-module application, the inductor L11 is connected to the AC power source V_{AC} and serves as a shared input inductor.

The input power processing circuit of the second embodiment of FIG. 3 may also operate in coordination with two modular single-stage AC-to-DC converters, that is, the single-stage isolation converter includes two single-stage AC-to-DC converters as shown in FIG. 3. In other words, two modular single-stage AC-to-DC converters are connected in series and parallel for use. Since each modular single-stage AC-to-DC converter has been described in the above-mentioned FIG. 3, it will not be described in detail here.

Therefore, this circuit can further increase efficiency after improving the characteristics of the bridgeless circuit. By adjusting the bridge rectification and main power in the circuit structure, the conduction loss is reduced, thereby significantly increasing efficiency, especially in high-power applications. At the same time, due to the reduction in the number of components, the heat loss and overall power consumption of the circuit are reduced.

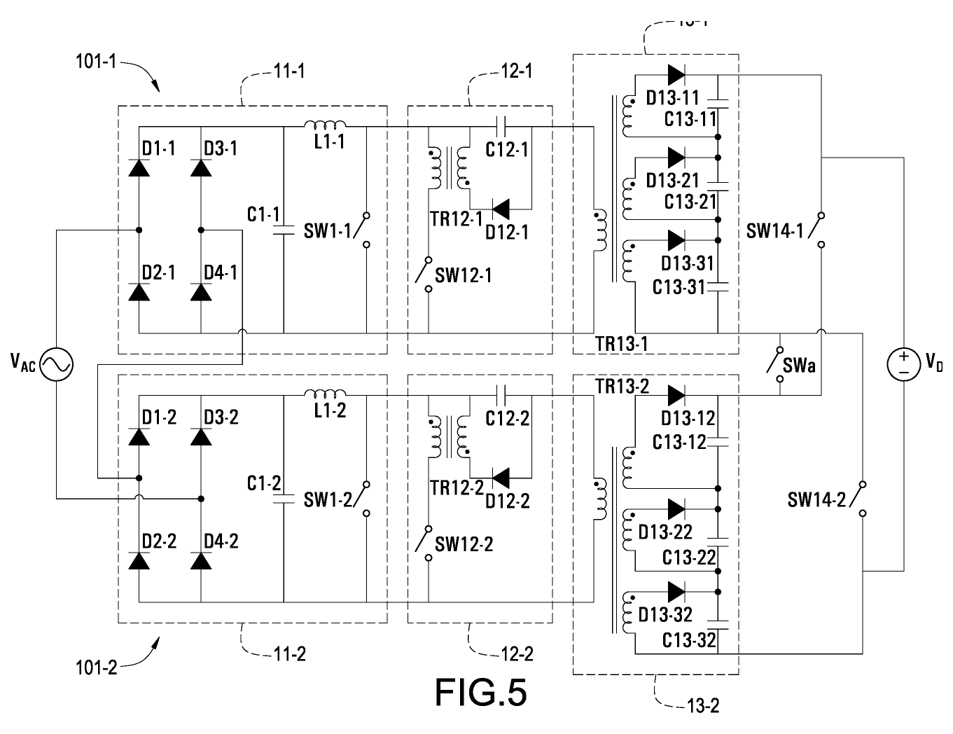

Please refer to FIG. 5, which shows a circuit diagram of two single-stage AC-DC converters wherein an output circuit is implemented according to a second embodiment of the present disclosure. Compared with the transformers TR13-1, TR13-2 shown in FIG. 4 which are one-to-two transformers, the transformers TR13-1, TR13-2 shown in FIG. 5 are one-to-three transformers, that is, a ratio of the number of input windings to output windings of transformers TR13-1, TR13-2 is 1:3. By using the one-to-three transformers TR13-1, TR13-2, this circuit also serves as an AC-to-DC conversion circuit with a higher voltage output, thereby realizing an AC-to-DC single-stage isolation converter with a wide range of high voltage output (e.g., 800 to 1500 volts). As shown in FIG. 5, the three-phase AC-to-DC single-stage isolation converter may be flexibly connected in series and parallel to form the three-phase AC-to-DC single-stage isolation converter as before for the improvement.

The disclosed circuit designs the transformer as a one-to-two transformers. The main switch SW1 and the auxiliary switch SW12 on the primary side of the circuit and the boost auxiliary capacitor C12 can maintain the same voltage stress to achieve twice the output voltage, and the electrical specifications of the components on the secondary side can also be effectively reduced. If the transformer is designed as a one-to-three transformer, a higher output voltage capability can be achieved under the same voltage stress conditions.

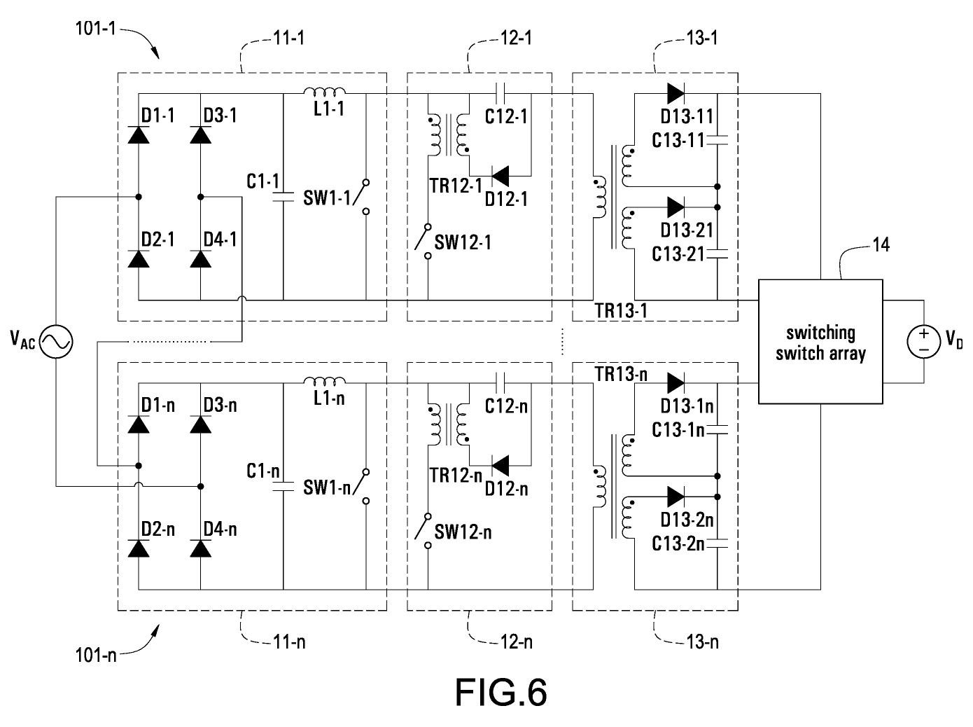

Please refer to FIG. 6, which shows a circuit diagram of n single-stage AC-to-DC converters operating in coordination with each other according to the present disclosure. In addition to the above-mentioned two single-stage AC-to-DC converters operating in coordination, it can also be expanded to n single-stage AC-to-DC converters operating in series or in parallel, where n is greater than or equal to 3, thereby achieving higher power specifications. Similarly, if the interleaving control is used, the high-frequency ripple of the circuit output can be reduced.

In particular, the structure shown in FIG. 6 includes a switching switch array 14. The switching switch array 14 may include a plurality of switch units. By turning on and turning off the switch units, the output sides of n single-stage AC-to-DC converters may be connected in series or in parallel to achieve an output power source V_{DC_OUT} with a wide output range.

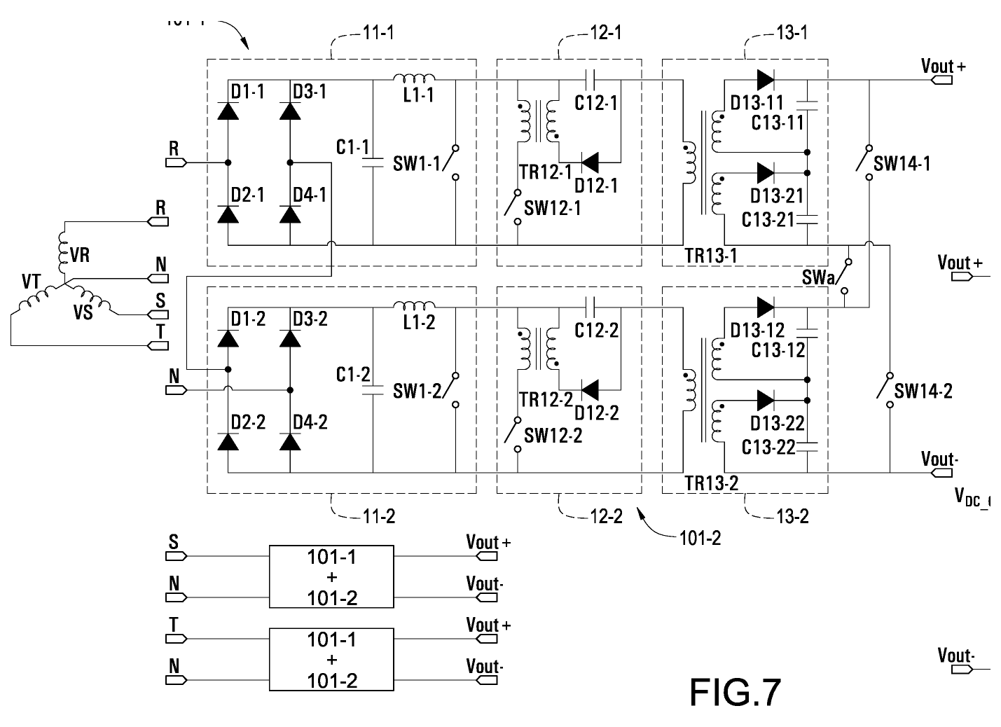

Please refer to FIG. 7, which shows a circuit diagram of a plurality of single-stage AC-to-DC converters applied to a three-phase circuit operation according to the present disclosure. This circuit is used as a single-phase AC-to-DC conversion circuit unit, and three identical circuit units are used to realize a three-phase AC-to-DC single-stage isolation converter with a wide range of voltage output. As shown in FIG. 7, in the R phase, the circuit structure shown in FIG. 4 is used. Similarly, in the S phase and the T phase, the circuit structure shown in FIG. 4 can be used respectively, thereby forming a three-phase AC-to-DC single-stage isolation converter with a wide range of voltage output.

In summary, the present disclosure has the following features and advantages:
1. Compared with the prior art, the circuit proposed in the present disclosure provides input to upper and lower sub-circuits (sub-modules), which can meet the requirement of increasing the upper limit of AC input voltage (for example, AC 220 volts increases to AC 480 volts), while effectively reducing the switching voltage stress of subsequent circuits.
2. By adding the zero-voltage auxiliary conversion circuit 12, the power switch with low switching loss (i.e., the auxiliary switch) is used to achieve zero-voltage switching of the power switch with low conduction loss (i.e., the main switch), thereby increasing the overall efficiency of the power switch.
3. By adjusting the frequency and duty cycle of the switching unit and the parameters of each component, a wide output range and high conversion efficiency can be achieved.
4. The disclosed circuit designs the transformer as a one-to-two transformer. The main switch and auxiliary switch on the primary side of the circuit and the boost auxiliary capacitor can maintain the same voltage stress to achieve twice the output voltage, and the electrical specifications of the components on the secondary side can also be effectively reduced. If the transformer is designed as a one-to-three transformer, a higher output voltage capability can be achieved under the same voltage stress conditions.
5. In practical application, the present disclosure can also add n input sub-circuits in series or in parallel to achieve higher power specifications. If the interleaving control is used, the high-frequency ripple of the circuit output can also be reduced.
6. The sub-circuits mentioned above may be independently controlled and thus can be flexibly connected in series and parallel to realize a higher specification single-phase single-stage AC-to-DC power module or a three-phase single-stage AC-to-DC power module.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A single-stage AC-to-DC converter comprising:
an input power processing circuit configured to receive an AC power source and convert the AC power source into a DC power source,
a zero-voltage auxiliary conversion circuit connected to the input power processing circuit, the zero-voltage auxiliary conversion circuit comprising:
an auxiliary transformer comprising a first side winding and a second side winding,
an auxiliary switch connected to the first side winding,
an auxiliary capacitor connected to the second side winding, and
an auxiliary diode connected to the second side winding and the auxiliary capacitor, and
an output circuit comprising an input side winding and an output side winding, the input side winding connected to the zero-voltage auxiliary conversion circuit,
wherein the input power processing circuit is configured to store energy provided by the DC power source during an energy storage cycle; the output circuit is configured to deliver the energy stored in the input power processing circuit to the output side winding during an energy release cycle to generate an output power source.

2. The single-stage AC-to-DC converter as claimed in claim 1, wherein the input power processing circuit comprises:
a bridge rectifying circuit configured to receive the AC power source,
an inductor connected to the bridge rectifying circuit, and
a main switch coupled to the bridge rectifying circuit in parallel.

3. The single-stage AC-to-DC converter as claimed in claim 1, wherein the input power processing circuit comprises:
an inductor configured to receive the AC power source,
a diode arm comprising a first diode and a second diode connected in series, and
a switch arm connected to the diode arm in parallel, comprising a first switch and a second switch connected in series.

4. The single-stage AC-to-DC converter as claimed in claim 2, wherein during the energy storage cycle, the auxiliary switch is turned on earlier than the main switch, and the main switch is turned on when a cross voltage of the main switch is zero.

5. The single-stage AC-to-DC converter as claimed in claim 2, wherein a first terminal of the first side winding of the auxiliary transformer is connected to the inductor and the main switch; a second terminal of the first side winding of the auxiliary transformer is connected to the auxiliary switch in series.

6. The single-stage AC-to-DC converter as claimed in claim 2, wherein a first terminal of the second side winding of the auxiliary transformer is connected to a first terminal of the auxiliary capacitor; a second terminal of the second side winding of the auxiliary transformer is connected to a cathode of the auxiliary diode; a second terminal of the auxiliary capacitor is connected to an anode of the auxiliary diode.

7. The single-stage AC-to-DC converter as claimed in claim 3, wherein a first terminal of the second side winding of the auxiliary transformer is connected to a first terminal of the auxiliary capacitor; a second terminal of the second side winding of the auxiliary transformer is connected to a cathode of the auxiliary diode; a second terminal of the auxiliary capacitor is connected to an anode of the auxiliary diode.

8. The single-stage AC-to-DC converter as claimed in claim 3, wherein in an energy storage period of one half cycle, the second switch is turned on, the auxiliary switch is turned on earlier than the first switch, and the first switch is turned on when a cross voltage of the first switch is zero; in the energy storage period of the other half cycle, the first switch is turned on, the auxiliary switch is turned on earlier than the second switch, and the second switch is turned on when a cross voltage of the second switch is zero.

9. The single-stage AC-to-DC converter as claimed in claim 3, wherein a first terminal of the first side winding of the auxiliary transformer is connected to the diode arm and the switch arm; a second terminal of the first side winding of the auxiliary transformer is connected to the auxiliary switch in series.

10. The single-stage AC-to-DC converter as claimed in claim 1, wherein the output circuit comprises:
a transformer comprising the input side winding and the output side winding, wherein a ratio of the number of the input side windings to the number of the output side windings is 1:m, where m is greater than or equal to 2, and
at least two capacitors respectively coupled to the output side windings to provide the output power source.

11. An AC-to-DC conversion apparatus comprising:
a plurality of single-stage AC-to-DC converters, each single-stage AC-to-DC converter comprising:
an input power processing circuit configured to receive an AC power source and convert the AC power source into a DC power source,
a zero-voltage auxiliary conversion circuit connected to the input power processing circuit, the zero-voltage auxiliary conversion circuit comprising:
an auxiliary transformer comprising a first side winding and a second side winding,
an auxiliary switch connected to the first side winding,
an auxiliary capacitor connected to the second side winding, and
an auxiliary diode connected to the second side winding and the auxiliary capacitor, and
an output circuit comprising an input side winding and an output side winding, the input side winding connected to the zero-voltage auxiliary conversion circuit,
wherein the input power processing circuit is configured to store energy provided by the DC power source during an energy storage cycle; the output circuit is configured to deliver the energy stored in the input power processing circuit to the output side winding during an energy release cycle to generate an output power source,
wherein the input sides of the single-stage AC-to-DC converters are respectively connected to the AC power source, and output sides of the single-stage AC-to-DC converters are connected in parallel or in series to output the output power source.

12. The single-stage AC-to-DC conversion apparatus as claimed in claim 11, wherein the input sides of the single-stage AC-to-DC converters are connected in series to the AC power source.

13. The single-stage AC-to-DC conversion apparatus as claimed in claim 11, wherein the main switches of the single-stage AC-to-DC converters are synchronously controlled; the auxiliary switches of the single-stage AC-to-DC converters are synchronously controlled.

14. The single-stage AC-to-DC conversion apparatus as claimed in claim 11, wherein the main switches of the single-stage AC-to-DC converters are interleavingly controlled; the auxiliary switches of the single-stage AC-to-DC converters are interleavingly controlled.

15. The single-stage AC-to-DC conversion apparatus as claimed in claim 11, further comprising:
a switching switch array connected to the output sides of the single-stage AC-to-DC converters, comprising at least one first switching switch and a plurality of second switching switches, wherein the at least one first switching switch and the plurality of second switching switches are turned on and turned off to decide whether the output sides of the single-stage AC-to-DC converters are connected in series or in parallel.

16. The single-stage AC-to-DC conversion apparatus as claimed in claim 15, wherein the number of the at least one first switching switch is equal to the number of the single-stage AC-to-DC converters minus one; and the number of the second switching switches is equal to the number of the single-stage AC-to-DC converters.

17. The single-stage AC-to-DC conversion apparatus as claimed in claim 11, wherein the single-stage AC-to-DC converters are respectively connected to three phases of the AC power source as a three-phase AC power source.
